(19) United States
(12) Patent Application Publication
(10) Pub. No.: US 2014/0053099 A1
(43) Pub. Date: Feb. 20, 2014

(54) User Initiated Discovery of Content Through an Augmented Reality Service Provisioning System

(71) Applicant: LAYAR BV, Amsterdam (NL)

(72) Inventor: Dirk Groten, Amsterdam (NL)

(73) Assignee: LAYAR BV, Amsterdam (NL)

(21) Appl. No.: 13/966,564

(22) Filed: Aug. 14, 2013

(30) Foreign Application Priority Data
Aug. 14, 2012 (EP) 12180464.5

(51) Int. Cl. G06T 19/00

(52) U.S. Cl. CPC G06T 19/006
USPC 715/790

(57) ABSTRACT

Methods for enabling discovery of content through an augmented reality service provisioning system. A first augmented reality client running on user equipment is provided, wherein the first augmented reality client is embedded in a third-party application, and is configured to allow a user to view at least part of the content offered by the augmented reality service provisioning system. A first input is received from a user through a user interface provided by the user equipment, wherein said first input indicates the user's interest to discover other content. In response to receiving the first input, a request is transmitted to a server in the augmented reality service provisioning system to retrieve relevant content from the other content; wherein the other content is content that the first augmented reality client is not configured to view.

### FIELD OF INVENTION

The disclosure generally relates to retrieving content for a user and enabling a user to discover more content offered by an augmented reality service provisioning system. In particular, though not necessarily, the disclosure relates to methods and systems facilitating the retrieval of more content, and the discovery thereof, for use in an augmented reality service provisioning system.

### BACKGROUND

The discussion below is merely provided for general background information and is not intended to be used as an aid in determining the scope of the claimed subject matter.

The recent convergence of mobile telecommunications, imaging systems and multimedia techniques enable the realisation of mobile services wherein real-world scenery seen by a user is enhanced with computer-generated imagery. These services, which are generally referred to as augmented reality (AR) services, are currently implemented on mobile multimedia devices.

Typically such services involve retrieval of digital data from a network server on the basis of the geographical location of the mobile device on which an AR client is executed. The digital data may be displayed to the user in the form of a computer-generated graphical layer overlaying the real-world scenery seen by the user on a graphical user interface (GUI).

The graphical layer may include visual information indicators associated with real-world objects and locations in the scenery. Such an indicator, which hereafter is generally referred to as a Point Of Interests (POI), may include graphical information and/or selectable links allowing a user to access further sources, e.g. web pages, audio and media files, etc.

Currently, the first systems hosting such mobile AR services are set up and rapidly growing in popularity. One key feature for rapid adoption by users is the use of an open architecture. For example the Layar® AR platform uses a standardized publicly available layer data structure, a “layer”, defining a set of parameters for a client to generate an overlay graphics plane over a camera view of a mobile device, thereby allowing third party content providers to design their own layers. Each layer comprises a particular set of POIs, and the content providers may add layer(s) to the existing collection of layers that is managed by a layer proxy. Using a layer database comprising URLs of the content providers and layer metadata, the layer proxy enables an AR client to retrieve POIs associated with a user-selected layer.

Implementation of an efficient and scalable content retrieval system, which is suitable for an open architecture AR platform like Layar, is a challenge, as the centrally stored layers in the layer database only comprise global information on a layer and no detailed “local” information on the POIs associated with the layers.

One scheme for searching relevant POIs within a certain area around the location of an user is described in co-pending European patent application EP10005743.9, entitled “Acquiring, ranking and displaying points of interest for use in an augmented reality service provisioning system and graphical user interface for displaying such ranked points of interests”, which is hereby incorporated by reference into this application. That application describes systems and methods for searching POIs and generating a ranked list of POIs in response to a geo-located search query. Although such search functionality greatly enhances the usability of the AR platform, integration of at least part of the AR services offered by the AR platform into other mobile applications is highly desirable.

Integration into mobile applications may be achieved by allowing AR services to be embedded in an application. For example, the AR platform may offer a developer of mobile applications an AR client as an executable binary file, e.g. a dynamic-link library file, which may be invoked by an application.

Developers however may be reluctant to use such embedded AR services as the content made available through such embedded AR client may distract the user from the content and services being provided by the third-party application or in the worst case, it may cause the user to leave the application and continue with the AR service. This is undesirable for the third party developer (and perhaps dis-incentivizes the third party) to embed an augmented reality client in their third party application if users are being taken away from the third-party application to other content/services. For instance, it may be undesirable for such third-party application to allow the embedded AR client to provide AR content that is not provided or pre-approved by the third party.

At the same time, users may be reluctant to leave the third-party application to discover content, unless the content is relevant, interesting, contextually important, and/or salient to the users. Retrieval of content based on (only) geographical location may not be sufficient to entice users to leave the third-party application to discover more content.

Hence, there is a need for methods and systems which enable integration of AR services offered by a AR platform into a mobile application, to allow and enable a user to discover (other) content offered by the augmented reality service provisioning system without being intrusive to the content and services provided by a third party application.

Furthermore, there is a need for an improved method and/or system for retrieving content that is relevant and/or salient to the user, thereby facilitating the user-initiated self-discovery of more layer content.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

To add augmented reality content and functionality into a third-party application, developers may add a piece of software code to embed an Augmented Reality Client as a binary package. The embedded Augmented Reality Client may also be interchangeably referred to as the embedded AR client, or simply the embedded client. The embedded AR client plays a published layer directly in the third party application.

Known GUI implementations for providing augmented reality content include composing a computer-generated graphical layer with the image of the real world scenery as captured by a digital camera of the mobile device. Other implementations may include displaying of the graphical layer to the user through wearable devices (e.g., glasses or googles), and/or projecting the graphical layer directly onto the real world scenery. The graphical layer may include at least one of: indicators for points of interests, computer-generated graphics, text, and images, etc.

The embedded AR client can be compared with an embedded video or embedded object such as a video object (e.g., flash object) which web developers can embed on a website using a line of software code. The embedded AR client plays any of the third-party's layers that the third-party application developer configures the embedded AR client to play. The embedded AR client may display the layer(s) in Augmented Reality view, map view, and/or list view (details of which are explained in detail herein).

In some embodiments, a link or icon is provided in the third-party application that allows the user to activate the embedded AR client to view the third-party's published layer(s). In this manner, the third-party application can access and leverage the benefits (e.g., content and features) offered by the augmented reality service and provisioning system, but yet does not require that the user to have the AR client installed on the user equipment. The “AR client”, as used without the wording “embedded” or “stand-alone”, refers to both the embedded AR client and the stand-alone AR client.

In this situation, it is desirable for the developer and/or provider for augmented reality content and functionality to use this opportunity (i.e., usage of the embedded client) to enable users to view, discover, or explore more AR content that may be relevant to the user and/or other AR content that is not available to the user through the embedded AR client. Furthermore, it is advantageous for the developer and/or provider for AR content and functionality to allow/enable more users to obtain, download and/or install their own (i.e., “stand-alone” or in other words, not embedded within a third-party application) AR client on user equipment. Moreover, it is advantageous to the AR developer/provider to enable users to continue to be able to take advantage of AR content and functionality even when users are not using the third-party application, thereby increasing market share, number of active users of the AR client, number of first time users of the AR client, amount of active usage of the AR clients.

While it is to the advantage of the third-party developer to provide a more enriching experience to their users of the third-party application, it may be undesirable to allow the AR developer/provider to distract the user from using and enjoying the third-party application. Users may leave the third-party application to view other content, such as content that is not supported, approved, authorized and/or provided by the third-party developer.

As one aspect of the present invention, the embodiments disclosed herein allow users to discover more content while providing the option to discover more content in a discrete or non-intrusive manner.

Moreover, users may be reluctant to leave the third-party application to discover content, unless the content is relevant and/or salient to the user. Traditional retrieval of points of interests based on geo-information may not be sufficient to entice users to leave the third-party application to discover more content. Because the AR client is embedded within a third-party application, there is an opportunity to leverage and/or harvest contextual information from at least one of: the user, the third-party application, the embedded AR client. This added information is useful for guiding the retrieval of more content (items) such that the retrieved points or content items are relevant and salient to the user.

The retrieval and display of relevant content to the user, in one embodiment, in an abstract or summary or digest form, facilitates the process of user-initiated discovery of layer content. Advantageously, more content is provided to the user without requiring significant amount of user input or specification. In some embodiments, the search results may provide a digest of the relevant content retrieved. The digest may summarize or at a higher level represent the content items retrieved, rather than displaying the content items themselves. A digest provides a simpler way of displaying the retrieved content items. For instance, the relevance of the retrieved content items may be more easily understood if (only) the icons and/or description of the layer(s) or group(s) or category(s) to which the retrieved content items belong is shown. If the user or the embedded AR client is not authorized to view a particular content item retrieved, then a digest may protect the content item while providing some indication to the user what the content item may be. In some instances, the indication may trigger the user to purchase the content to obtain authorization to purchase the content. In certain instances, the indication may trigger the user to use a separate AR client to view the content. In the context of this application, a digest comprises a compilation or summary of material or information relating to one or more content items.

A method for enabling content discovery on user equipment in an augmented reality service provisioning system is disclosed. A first augmented reality client for running on the user equipment is provided, wherein the first augmented reality client is embedded in a third-party application, and is configured to allow a user to view one or more first content items offered by the augmented reality service provisioning system. A first user input is received, through a user interface provided by the user equipment, wherein said first input indicates a user's interest to discover further content different from the one or more first content items, wherein the first augmented reality client is not configured to (or authorized) view the further content. In response to receiving the first input, a request is transmitted for the further content to a server in the augmented reality service provisioning system to retrieve one or more second content items within the scope of the further content. An abstract search result representing the one or more second content items (or a digest of the one or more second content items) retrieved is provided, wherein at least part of the abstract search result to be displayed on the user equipment.

The invention relates to a computer program product, wherein the computer program product may comprise software code portions configured for, when run a computer, executing the method steps according to any of the methods described herein.

Aspects of the invention will be further illustrated with reference to the attached drawings, which schematically show embodiments according to the invention. It will be understood that the invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 depicts a schematic of an illustrative AR service provisioning system;

FIG. 2 depicts exemplary GUIs of a third-party application and an embedded AR client;

FIG. 3 depicts exemplary GUIs of a known AR service;

FIG. 4 depicts a schematic of an AR service provisioning system for providing mobile AR services to stand-alone and embedded AR clients according to several embodiments of the invention;

FIG. 5 depicts a schematic depicting the interactions between the embedded AR client and parts of AR service provisioning system for providing mobile AR services to the embedded AR client according to some embodiments of the invention;

FIG. 6 depicts an exemplary flow diagram of a POI feedback process, used connection with both stand-alone and embedded AR clients, according to one embodiment of the invention;

FIG. 7 depicts an exemplary flow diagram of generating a ranked POI database, used in connection with both stand-alone and embedded AR clients, according to one embodiment of the invention;

FIG. 8 depicts an exemplary flow diagram of the execution of a POI search, used in connection with both stand-alone and embedded AR clients, according to one embodiment of the invention;

FIG. 9 shows an illustrative flow diagram of the method for providing a list of relevant layers to the user, according to one embodiment of the invention; and

FIG. 10 shows an illustrative flow diagram of the method for enabling user discovery of content, according to one embodiment of the invention.

### DETAILED DESCRIPTION OF THE ILLUSTRATIVE EMBODIMENTS

Third-party applications may embed an AR client configured to offer an AR experience to its users, even though, in some situations, the users may not have the AR client already available in the user equipment. For purposes of illustration, an example third-party application is used to describe the implementation of the methods and systems described herein. Nonetheless, it is to be understood that the disclosure is not limited to the example third-party application discussed herein.

One possible example of a third-party application is an application created for a theme park. The theme park application may be provided on a smart phone or some other mobile electronic device. This theme park application may provide information about various attractions located within the theme park. For instance, users may use the theme park application to view live webcam video feed of the attractions, read information about the history or background of the attraction, pay for tickets to the attraction(s), purchase related media items such as movies or music, select and save a listing of interesting attractions, send information about a particular attraction to a friend, etc. In addition to offering features like ones listed above, the theme park application may embed an AR client (interchangeably referred to as the embedded AR client or the embedded client) in the third-party application to provide an AR experience to the user. Once activated, the embedded AR client provides layer content to the user as a computer-generated graphical layer using aspects of systems and methods described herein. Layer content may include any content provided by the AR service provisioning system, such as data and/or content related to layers, objects, and/or POIs.

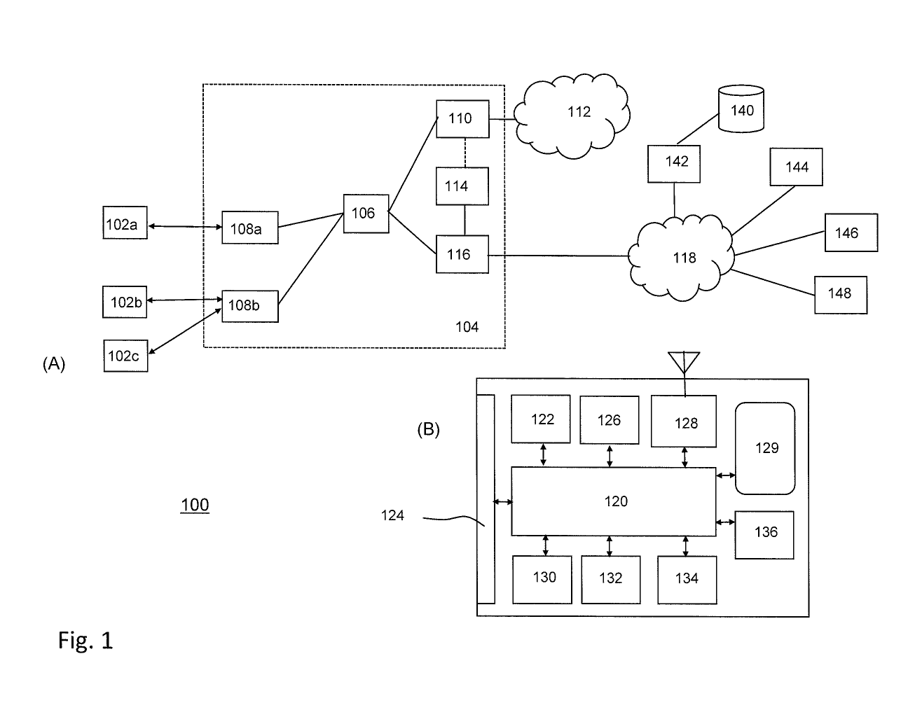

FIG. 1(a) depicts a schematic of an illustrative augmented reality service provisioning system 100 for providing mobile AR services to AR clients. The system comprises one or more mobile user equipment (UEs) 102a-c connected to wireless network 104. Such wireless networks typically include networks which are implemented in accordance with the 2G, 3G or UMTS-based technologies. A wireless network may include a number of network nodes, e.g. a Base Station Controller 106 (BSC) for controlling a number of access nodes 108, typically referred to as base stations, each covering a certain area (cell), Mobile Switching Centre (MSC) 110 for connecting UEs to fixed line telecommunications network 112, e.g. a PSTN, a Home Location Register (HLR) comprising 114 information associated with subscribers to the mobile services offered by the wireless network and Serving General Support Node (SGSN) 116 for connecting UEs to one or more public or private data networks 118 such as the Internet. Alternatively and/or in addition UEs may be connected to public or private data networks, e.g., wirelessly through, e.g., a local Wi-Fi or WiMax network (not shown).

Each UE, schematically shown in more detail in FIG. 1(b), may generally comprise processor 120 for executing and managing Operating System (OS) 122, a User Interface (UI) including selectable display 124 and software applications (e.g., system applications, third-party applications), which may be stored in non-transitory computer storage such as memory 126. Instances of said software applications is represented by element 129. In some embodiments, said software applications may be implemented in hardware such as Field Programmable Gate Arrays. The OS may execute client software such as HTTP and/or SIP clients for setting up web-based services and/or streaming services to interact/communicate with servers such as content providers over, e.g., network 118. The UE may comprise network card module 128 comprising a base band processor (BP) for controlling the radio communications between the ME and an access node of a wireless network using a RF communications interface. Network access and authentication may be controlled using a SIM card connected to the processor.

The UE may further comprise digital imaging system 130 comprising a lens system, an image sensor and an imaging processor connected to the GUI which is configured to generate a camera view and sensor modules for generating positional information associated with the UE, i.e. the geo-coordinates and the attitude. Such sensor modules, which are known per se, may include GPS receiver module 132 for generating the geo-coordinates longitude and latitude of the mobile device, magnetometer 134 for determining direction (rotation around the vertical axis) and an accelerometer 136 for determining the tilt (the angle with respect to the earth's gravitation vector). In one embodiment, the tilt parameter generated by accelerometer 136 may be used for determining and displaying the horizontal plane in order to display objects correctly in the camera view.

In general, if a stand-alone AR client is already installed on the UE, the stand-alone AR client stored in the memory of the UE may be activated by the user to provide AR services to the UE through the user equipment's operating system.

In the AR service provisioning system depicted in FIG. 1, a layer may be defined according to certain publicly available standard rules/templates, thereby allowing third parties, typically content providers 144, 146, 148 (e.g., third-party developers), to define layers associated with different subjects, objects or services, e.g. lifestyle, restaurants, shopping, banks, housing, etc. Hence, content providers 144, 146, 148 or a third-party developer may design/provision its own layer in accordance with the standard rules and submit metadata associated with the layer, i.e. an URL for retrieving the POIs, a layer subject, layer layout information, etc., to the AR system so that it is known from which server the layer data (the actual POIs) may be retrieved. In some embodiments, an embedded AR client may be configured to view, access, and/or interact with the particular layer that the third-party has authored.

For instance, the developer for the illustrative theme park third-party application, as a content provider, can publish at least one layer providing information related to attractions located within the theme park (e.g., rollercoasters, themed thriller rides, restaurants, restrooms, locations of queues. Likewise, the illustrative theme park application developer may also publish layer content related to objects located outside of the theme park, such as authorized retailers for selling theme park branded merchandize, or billboards/advertisements located outside the theme park.

To manage layer content, the AR service provisioning system stores the metadata associated with the available layers in layer database 140. If a user selects a particular layer, the AR client transmits a request, e.g., a HTTP GET request getPOI, to layer proxy 142. On the basis of the information in the request, layer proxy 142 may retrieve the URL associated with the selected layer and subsequently relays the request to a server of one of the content providers 144-148. On the basis of the geo-information in the request, the relevant POIs, including metadata associated with the POIs, e.g., the geo-coordinates of each POI, are determined and returned in a response message to the AR client. In some embodiments, the relevant POIs may be determined based in part on contextual information, preferably for use with the embedded AR client. The AR client, stand-alone or embedded, uses the layer metadata in order to generate a graphical overlay including the various POIs and to display the graphical overlay in the camera view. Besides getPOI, other types of requests may include getLayers, getLayerDetails, getStreamItems, postFeedbackCalls.

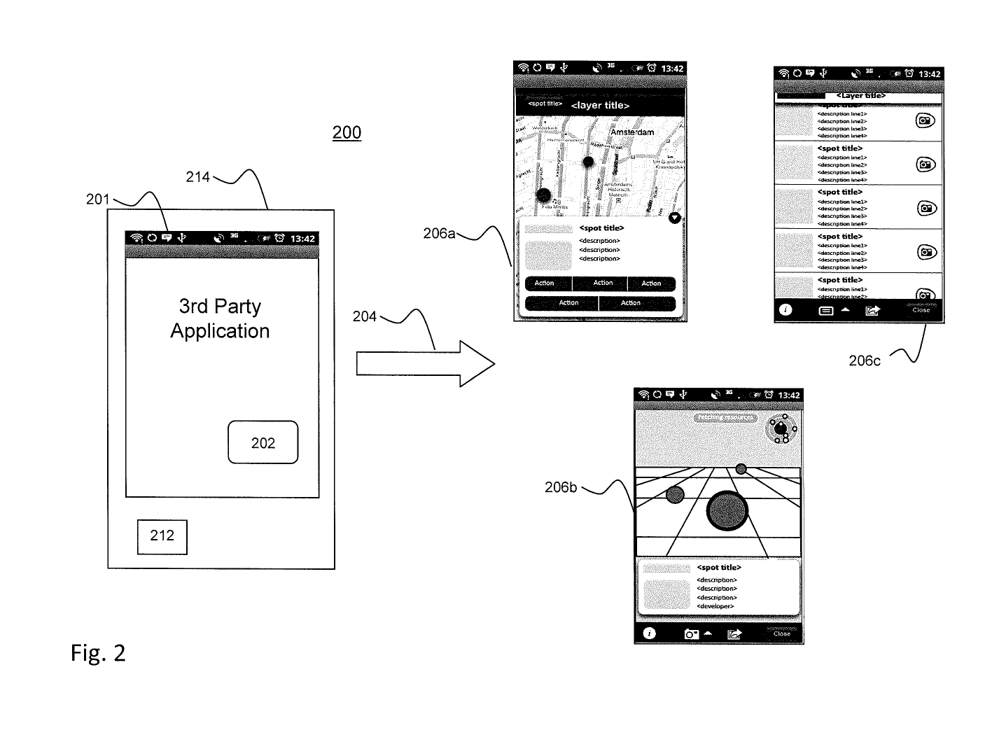

To further illustrate the user interaction experience of the embedded AR client within a third party application, FIG. 2 depicts exemplary GUIs of a third-party application and an embedded AR client.

In some embodiments, third-party application 201 running on user equipment (UE) 214 may provide an embedded AR client 212 for providing AR content and features. In those cases, third-party application 201, which embedded AR client within its software package, activates (represented by arrow 204) the embedded AR client 212 at an appropriate time for use within the third-party application running on the user equipment.

The third-party application may provide the embedded AR client access to data collected by various components in the UE, such as accelerometer 136, magnetometer 134, GPS receiver module 132, digital imaging system 130 (as seen in FIG. 1), and any other suitable components needed for running the embedded AR client 212. For instance, if a user has clicked on an icon or link (represented by element 202) to view published layer(s) associated with third party application 201, third-party application 201 may activate the embedded AR client to provide the layer content as well as any suitable AR features and functionality. In some embodiments, the embedded AR client may be activated based on other conditions and/or user input.

Activation 204 of the embedded AR client may include software instructions to configure the user equipment to run the software package for the embedded AR client. In some embodiments, activation 204 comprises executing software instructions to load and run the executable package of the embedded AR client. In certain embodiments, third-party application 201 provides sensor information (e.g., geo-information, directional information, etc.) to the embedded AR client to aid in the retrieval of nearby points of interests. In some embodiments, the embedded AR client gains access to components in the UE to gather sensor information, and any other components needed to run the embedded AR client, such as the display, user input interfaces, data interfaces, processor, etc.

Using at least the sensor data provided by the UE, the embedded AR client transmits a request to retrieve content for the user (e.g., through a network card or suitable data communications module). The request may be generated based on the configuration provided by third party application 201. For instance, the retrieval of data may be limited to only the layers published by the third party developer providing third party application 201. Nonetheless, the embedded AR client transmits a request to the layer proxy (such as layer proxy 142) to retrieve content to be displayed. The content retrieved by the embedded AR client may include layer information. In one embodiment, the layer information is the information with respect to the layer(s) published by the third party developer. The layer information is preferably not layer(s) published by other parties. The content retrieved may include metadata. In particular, the content may include metadata associated the POIs (or other types of content items) from the layer(s) published by the third party developer. The metadata may include instructions for fetching content from a content provider to enable a more distributed system for increasing scalability.

Based on the retrieved content (preferably transmitted as a response back to the user equipment from the layer proxy), third-party application 201 may configure the embedded AR client to display the retrieved content in any of the views available on the embedded AR client. Examples are shown as screen shots 206a-c. Screen shot 206a is an exemplary map view, where POIs are displayed on a 2D map. POIs may be highlighted or selected, and its metadata and/or content may be displayed. Screen shot 206c is an exemplary list view, where POIs are displayed in a list format, where in each list item, the icon and any associated data is displayed for the POI. Screen shot 206b is an exemplary AR camera view. POIs are displayed as a graphical layer on top of the images as received by the camera of the user equipment.

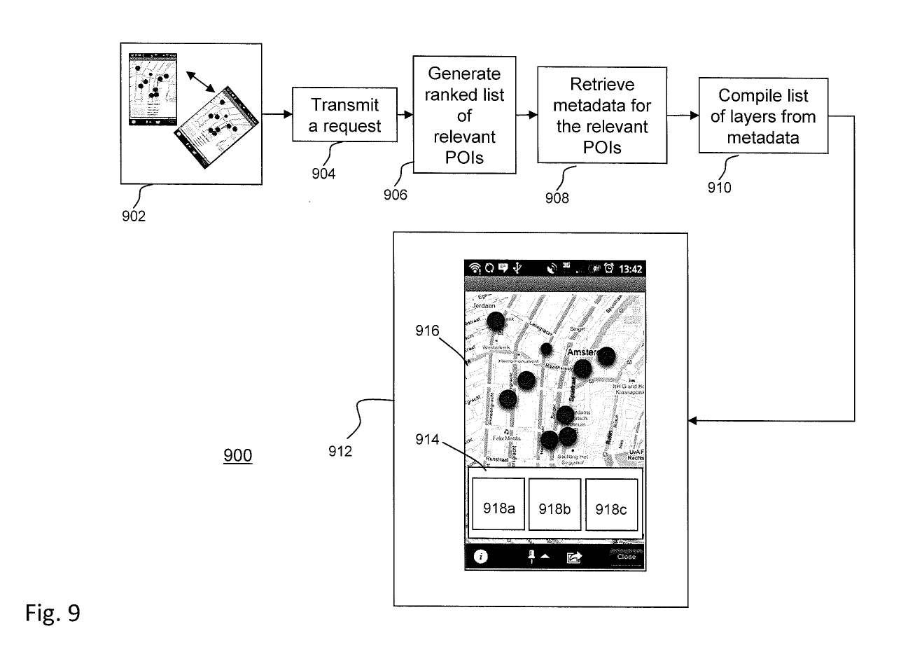

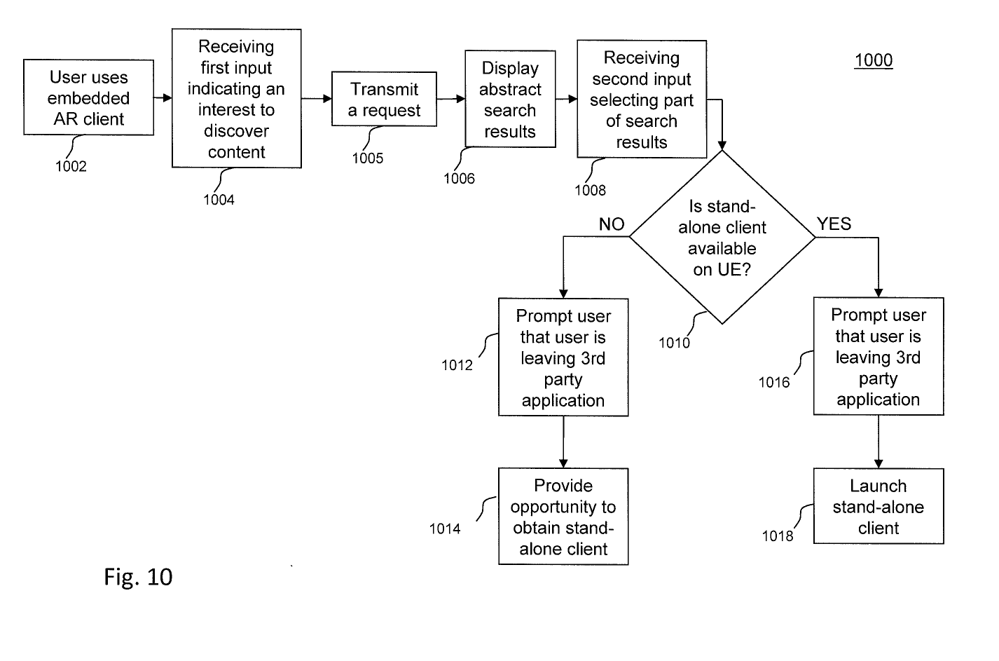

For instance, the theme park application may configure the embedded AR client to display published layers associated with the theme park. Based on those layers, the layer proxy (such as layer proxy 142) would retrieve relevant POIs (or other types of content items) for the user based in part on geo-information and/or contextual information (about the user, the third-party application, or the moment in time) and provide those retrieved POIs to the user. If the user is located within the theme-park, the nearby attractions may be displayed in map, list or AR camera view via the embedded AR client (see screen shots 206a-c). In the event that no relevant POIs are returned (e.g., the user is far away from the theme park), then a request for other relevant content may be executed automatically without further user input to request for said relevant content. This type of request is explained in further detail in relation to FIGS. 9 and 10.

An embedded AR client, while offering common features and functionality as a stand-alone AR client, may include certain mechanisms to limit or enhance the selection of the particular layer or POI content that is accessible or viewable using the embedded AR client. An embedded AR client may offer at least one of: AR view, map view, and list view. These views are provided to the user via the user equipment in a similar manner as a stand-alone AR client.

Users may use the embedded AR client to, for example, view POI icons/content, browse POI lists, view the world through Augmented Reality etc.

The embedded AR client may include a view controller that is configured to manage the functionalities of the graphical user interface. The third-party developer may pass certain parameters to configure the embedded AR client such that the appropriate view and/or data is presented to the user when the embedded AR client is activated. Depending on the configuration of the embedded client (e.g., using parameters described above), the third-party application may activate the embedded client and begin with in any one of: AR view, list view, or map view. This may be performed by passing a parameter to a view controller within the embedded AR client.

The third-party application may provide a button, link, or any suitable object (represented as element 202 of FIG. 2) that can be directly or indirectly invoked by the user for activating the embedded AR client. In some embodiments, the user may select, depress, click, or provide any suitable user input to activate the embedded AR client within the third-party application. In certain embodiments, the third-party application may activate the embedded AR client based on other non-user input. For instance, the third-party application may activate the AR client (without explicit user input) if the third-party application has detected that the user has entered a haunted house, or a maze (e.g., based on the location of the user equipment).

In one embodiment, the third-party developer published a plurality of layers. In that case, when the embedded AR client is first activated, a user may be taken to the list view to view a list of said plurality of layers. The layers to be made available to the user though the embedded AR client may also be configured by the third-party application, by passing the name(s) of the layer(s) as a parameter to a view controller in the embedded AR client.

Alternatively, the user may be brought to the list view, map view or AR view (see exemplary screen shots 206a-c) to see relevant POIs (or other suitable types of content items) from the plurality of layers. The user may view POIs nearby as if the plurality of layers had already been activated or selected for viewing in the graphical layer.

If the third-party developer published only one layer, the user may be taken to directly to the map view, (POI) list view or AR view to view the POIs available in that particular layer. In general, the interactive features available in the embedded AR client is comparable to the interactive features available in the stand-alone AR client. However, an embedded AR client, being configurable, allows third-party developers to exercise some control over the behaviour of the embedded AR client.

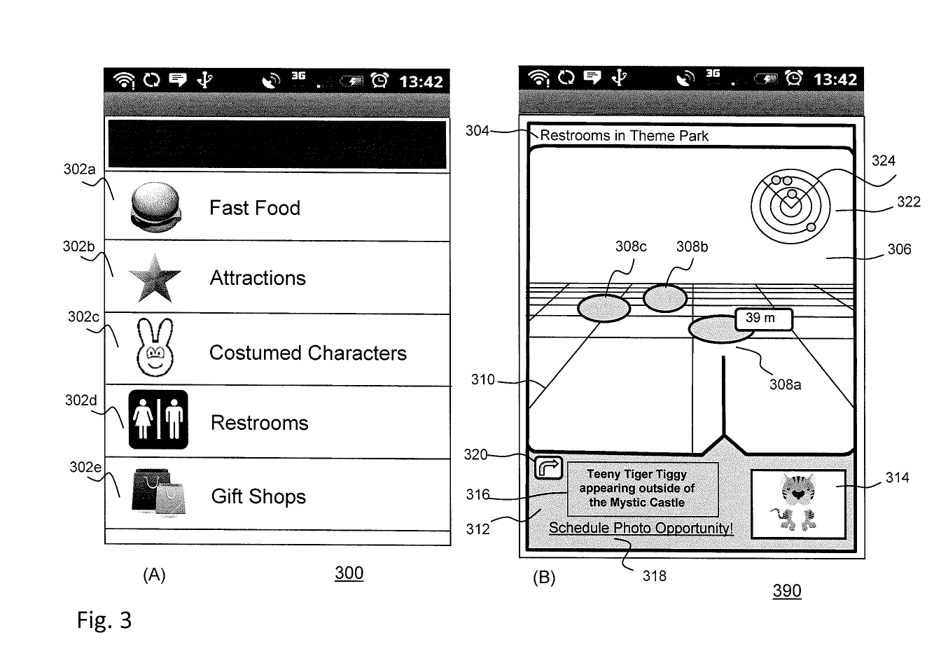

When using an AR client, embedded or stand-alone, a user may select a layer from a listing of available layers in a layer list view as depicted by the GUI layout in FIG. 3(a). In embodiments where an embedded AR client is used, the third-party developer may have configured the embedded AR client to be able to access a plurality of layers. The plurality of layers may then be shown in the listing of available layers in list view.

By sending a request to layer proxy 142, an embedded AR client may retrieve information about layer(s), e.g., layers published by the third-party developer, from the layer database and present the available layers 302a-e to the user (i.e., in list view 300). For example, this retrieval of layer information may be performed by transmitting a getLayerinfo request. Authentication and/or authorization mechanisms may be used to implement access control over the layers available in the layer database. In this example, the theme park application has published at least five layers: “fast food restaurants” in theme park layer, “attractions” in theme park layer, “costumed characters” appearing in theme park layer, “restroom facilities” located in theme park layer and “gift shops” in theme park layer.

Upon selection of a layer by the user, e.g., restrooms layer 302d as depicted in the example of FIG. 3(a), the AR client transmits a request via the layer proxy (e.g., layer proxy 142) to a content provider (e.g., a content provider associated with the third-party developer) to retrieve the POIs associated with the selected layer. Further, the AR client may switch over to AR camera view 390 wherein POIs within the range of view are displayed as a graphical layer over the images taken by the camera of the user equipment. On the basis of the information in the response and sensor information, the AR client may generate AR camera view 390 (or interchangeably referred to as the AR view) as depicted in FIG. 3(b).

In AR view 390, the AR client (standalone or embedded) may generate on the basis of the location information provided by the GPS module and/or the digital imaging system, a so-called AR camera view wherein a digitally generated graphical overlay, i.e. a layer comprising geo-coded information in the form of one or more POIs, i.e. indicators, typically graphical indicators, associated with an geo-located object, message, person, action or location in the camera view. A POI may provide information, e.g., a text, a message, a post, a tweet, images or (3D) virtual objects, or an indication for an action, an interactive object, selectable links or buttons allowing a user to view further digital sources, video and/or audio or a webpage, opportunity to execute an application, sending an SMS or starting a call, etc. Further, a POI may comprises a geo-location, i.e. geo-coordinates locating it on the Earth's surface (e.g. lat, long) and altitude information (e.g., z-coordinate) that may specify a POI to be located on the actual Earth's surface or anywhere above or below this surface.

The AR camera view GUI may comprise a (computer generated) graphical layer 304. Generally, the graphical layer may include a rendering of one or more content items associated with objects in the real world scenery. The content item(s) may be superimposed onto the object(s). In this example, a graphical layer may include icons representing restrooms located within the theme park, superimposed over a real-world window 306 for displaying the scenery to which the user equipment's camera is pointing. The layer may comprise a number of POIs 308a-c wherein each POI may be associated with a number of POI elements, e.g., text and picture windows, URLs, a select button for activating a multimedia or messaging service, location, distance, etc. A POI element may become visible when the user selects a POI or when a user is within a certain distance of the POI. The POIs, e.g., a disc-shaped POI, may be projected onto a 3D grid 310 and may change in appearance (e.g., size, shape and/or color) as a function of distance, health, and/or time. For example, in FIG. 3(b) the disc-shaped POIs become smaller in size when the distance between the POI and the AR client gets larger thereby producing a visual depth effect. Further, the AR client may automatically lock onto a POI 308a, which is at a distance closest to the user equipment and within the angle of view of the camera. Alternatively, a user may lock onto a POI by selecting it. When locking onto a POI a window 312 may comprising further information regarding the POI, including e.g. a picture window 314, a text window 316, an URL 318 and/or a selectable link 320.

The AR camera view, as seen in AR view 390, is limited by the angle of view of the camera, therefore, not all retrieved POIs, which are within a predetermined distance from the user equipment, are visible in the AR camera view. For that reasons the GUI may further comprise a small radar screen 322 providing a two-dimensional view of the POIs associated with the selected layer, which are available in the area surrounding the user equipment. A triangular area 324 in the radar screen depicts the area, which is covered by the AR camera view, and the POIs that are within that area (and thus visible in the AR camera view). For example in FIG. 3(b) one can determine on the basis of the radar view that three of the four POIs are displayed in the AR camera view.

In some embodiments, a map view (not shown) is used for graphically displaying POIs in a particular area. The map view comprises a graphical representation of the area projected in a two-dimensional space. The map may be an abstract representation of land, water, roads, buildings, or any applicable primitive geographical elements. The map may comprise of satellite images of the Earth. The map view also comprises at least one graphical overlay for displaying POIs located in the portion of the map being displayed on the user equipment. For instance, the map view may display the North-East quadrant of the theme park, and graphical icons may be used to indicate the locations of restrooms within that quadrant. An exemplary map view is shown as screen shot 206a of FIG. 2.

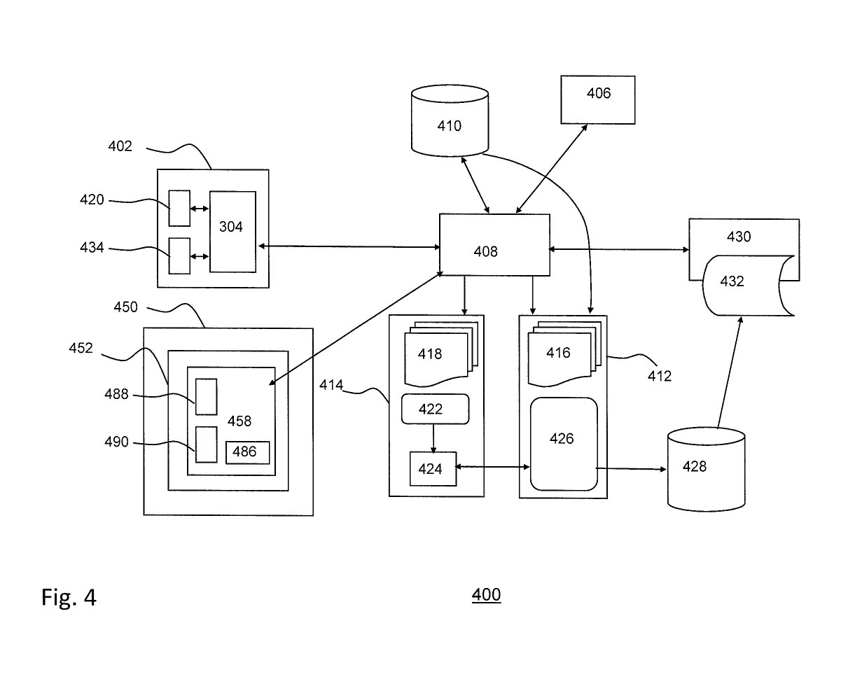

Published layer content may include POIs that are located far away from the user, or are irrelevant to the user. To filter out undesired POIs, a ranking system is used to search for POIs that are relevant to the user. The ranking system and methodology is described in further detail in relation to FIGS. 4, 6-8.

FIG. 4 depicts a schematic of an AR service provisioning system 400 for providing mobile AR services to stand-alone and embedded AR clients according to several embodiments of the invention. The AR system depicted in FIG. 4 allows a user to search POIs present within a certain distance from the user in accordance to a ranking scheme.

The system comprises one or more mobile devices (user equipment or UE) 402 and 450 which are configured to access fixed public and/or private data networks via, e.g., a wireless access network (not shown) in a similar way as described with reference to FIG. 1. The UE may comprise AR client 402 configured to generate an AR view on the basis of POI information from content providers 406. In the embodiment where an embedded AR client is used, the UE may comprise third-party application 452, which in turn comprises an embedded AR client (a binary package) 458.

Embedded AR client 458 may be configured to generate an AR view on the basis of at least parameters provided by the third-party application and/or sensor data provided by the user equipment. Further, AR client 402 and embedded AR client 458 are configured to receive location and direction information from sensors in the UE. In order to retrieve the relevant POI information, a layer proxy 408 may manage the request and response messages exchanged between an AR client and a server of a content provider on the basis of resource information in layer database 410.

Layer database 410 may further comprise a list of URLs associated with the content providers, user information, e.g. in the form of user profiles, and layer information (i.e. layer metadata such as information used to display a layer on the screen of a UE: title, publisher, description text, icons, color schemes; and information used by the AR system: list of countries where the layer is relevant, keywords for searching the layer, location information in the form of bounding geo-boxes to restrict places where layer should be shown, flags for opting out of certain services (e.g. the search service as described in more detail below), average time-to-live of the POIs and expiration date of the layer, etc.).

In some embodiments, the layer database may further comprise listing of third-party developers who had created third-party applications that had an embedded AR client, the third-party developer/application association(s) with particular layer(s), as well as any other information about the third-party application, such as location, language, locale, encryption/signature cryptographic keys or any suitable metadata associated with third-party applications/developers.

The AR system may be configured to record POI information that is exchanged between the AR client and the content providers for indexing purposes. To that end, layer proxy 408 may comprise (or may be connected to) POI recorder 412 and POI feedback recorder 414. The POI recorder monitors POI responses originating from the content providers and generates on the basis of the monitored POI responses a list of POIs 416, i.e. a POI queue representing a recorded list of temporally ordered POIs, which were sent by the content providers via the layer proxy to the AR clients. In one embodiment, on the basis of the metadata in the layer database and on the basis of the request parameters, the POI recorder may add contextual information, e.g., layer information and/or user information and/or distance information to each recorded POI. The POI feedback recorder may generate a list of POI events, i.e., a POI feedback queue 418, representing information regarding the “POI browsing history” of users of the AR system.

In certain embodiments, POI feedback recorder 412 may add contextual information using parameters provided by the third-party application and/or the embedded AR client (e.g., the parameters in the “get” requests transmitted by an embedded AR client). This may enable enhanced tracking of POI browsing history based on users of third-party applications and the contextual information provided in the requests sent by the third-party application and/or the embedded client. For instance, a parameter for “age group” may be sent as part of a getPOI request transmitted from an embedded AR client. The parameter may be recorded for tracking purposes, such that it may be used later to infer that certain POIs should be targeted to certain age groups.

To correlate POI information recorded by the POI recorder and the POI feedback recorder, each POI in the AR system may be assigned to a unique identifier POI_ID, which may be easily calculated on the basis of the layer metadata and the POI_ID included in the POI response. In one embodiment, the POI_ID may be defined as the hash of a layer identifier, which is unique within the layer database, and a POI identifier, which is unique within a particular layer definition.

The AR client may comprise a POI feedback function 420 and 488, which is configured to monitor and store a group of POI events and to periodically send the thus collected POI event information to the POI feedback recorder. POI events may generally relate to any type of information associated with a user interacting with POIs presented in the AR view on the user equipment. A POI event may include metadata associated with a selected POI, e.g., the POI_ID, and metadata associated with “user actions”, e.g., selection of a link associated with the POI, activation of a user selectable program, e.g., a media player or a widget, time information (e.g., time stamps) associated with such user actions and “local” user actions associated with a POI, e.g., selection of a POI as a favorite or tagging the POI with a user-defined tag. A POI event may also include distance information, i.e., at which distance the user interacting with the POI is located from the POI when the interaction occurs. In some embodiments, the contextual parameters in the requests transmitted by the embedded AR client is preferably stored as metadata of a POI event.

Using the POI events in the POI feedback queue, a popularity algorithm 422 in the POI recorder may assign popularity points to each POI in the queue. On the basis of the premise that the popularity and relevance of a POI relates to the frequency a POI and its contents are selected and accessed respectively, the popularity algorithm associates popularity points to each POI identified in the feedback queue and subsequently stores the result in a popularity cache 424, i.e., a fast read/write table. Hence, when using such popularity algorithm, a POI which is frequently selected and which contains frequently accessed contents, will in principle receive a higher popularity score than a less frequently visited POI.

The feedback recorder may continuously or periodically update the popularity cache on the basis of the POI events in the POI feedback queue, which is periodically fed by POI feedback function 420 and 488 in the AR client.

In one embodiment, a content provider may add POI lifetime information to a POI in a GetPOI response. The content provider may also add such lifetime information on the layer metadata level so that it will apply to all POIs within the layer unless overridden in the GetPOI response. In particular, when the information in a POI is only relevant for a short period of time, e.g. a POI associated with a Twitter tweet placed at a certain location by a user of the AR system, or when the information in a POI is highly dynamical, e.g. a POI associated with a player in a game, the POI lifetime information may allow the popularity algorithm to allow the POI to start with a relatively high popularity score but to decrease its score relatively fast if the POI is not accessed often enough.

A POI update function 426 in POI recorder 412 subsequently may generate on the basis of the POI queue and the information in the popularity cache, a list of POIs for storage in the POI database 428. The POI update function may be configured to retrieve a POI from the POI queue, to determine on the basis of the POI_ID whether the retrieved POI is listed in the popularity cache and—if so—to request its associated popularity score and the average interaction distance from the popularity cache 424 and to store the POI and the popularity score and average interaction distance in the POI database 428. If the POI is already listed in the POI database, the popularity score and/or average interaction distance of the POI is updated, otherwise the POI and its score and/or average interaction distance is added to the list. The POI database thus comprises a list of POIs, each identified by a POI_ID and a popularity score reflecting relevancy of the POI as determined by the users of the AR system.

A POI entry in POI database 428 comprising a POI_ID, the POI metadata (e.g. title, description, type of POI, keywords, tags, types of possible interactions), a popularity score, geo-coordinates, the average interaction distance, timestamp relating to the time of update and metadata from the layer database (e.g. keywords, category, etc.), may be indexed by search engine 430 known per se. When executing a search, search engine 430 uses the popularity score as a ranking parameter. In some embodiments, a keyword matching score may be used as a ranking parameter. Keyword matching score may be representative of the saliency of a particular POI based on a given set of keyword(s). Lifetime information associated with the POI may be used as a ranking parameter. When executing a POI search on the indexed file, the search engine may use several ranking parameters in order to determine a total ranking score of a POI.

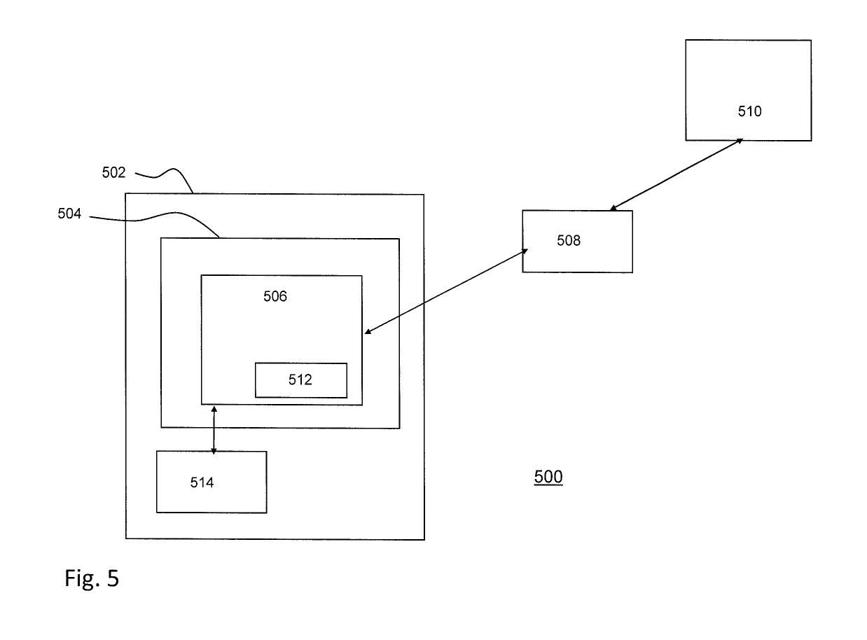

Search application 434 and 490 in the AR client may allow the user to input a search query, which is sent in a search request via the layer proxy server to search engine 430. In certain embodiments, embedded AR client 458 may also include search application 490 for executing a search for relevant/salient content for the user to facilitate discovery of other content. Third-party application 452 may configure search application 490 such that the search capabilities are limited, or such that requests transmitted from search application 490 include certain parameters provided by third party application 452. For instance, search application 490 may be configured to only search for POIs associated with a particular layer. To improve the search for relevant and/or salient POIs for the user, embedded AR client 458 may include context recorder 486 (which may be implemented together with POI feedback recorder 488) for gathering contextual information about the user, the third-party application, and the embedded AR client. Details regarding context recorder 486 is explained in further detail in relation to FIG. 5.

In some embodiments of search applications 434 and 490, the keywords portion of the search query may be empty, allowing the user just search for any content within a specified distance from the UE. In a further embodiment, the user may restrict the search query with filters, like categories of POIs (only search for POIs belonging to layers within one or more specific categories) or POIs matching a specific tag. These filters may be created using parameters provided by third-party application 458 and/or context recorder 486. On the basis of the search query, filters and geo-information of the user, the search engine may select the “local” POIs, i.e., the POIs, which are within a certain distance from the AR client, and search within this “local” group of POIs on the basis of the query and the ranking parameters as described above. The search results may be subsequently presented to the user in a ranked order as determined on the basis of the overall ranking score of each POI. The search result is provided via a GUI which allows user interaction.

It is appreciated that the invention is not limited to the system as depicted in FIG. 4. For example, in one embodiment, instead of one POI recorder and one POI feedback recorder (seen as POI recorder 412 and POI feedback recorder 414), there may be more than one feedback system for the generation of several ranked POI databases and/or index files. For example, a POI feedback queue may be generated on the basis of POI feedback information generated by predetermined group(s) of users or individual users. For instance, a separate feedback mechanism may be used for users using the embedded AR client in a particular third-party application. The separate feedback mechanism may lead to separate index files (implemented in a similar manner as indexed file 432), such that the interaction of the POIs from the embedded AR client can be tracked and monitored separately. In some embodiments, a similar, separate POI recording and ranking feedback mechanism may be used (not shown) for recording requests transmitted from third-party applications and embedded AR clients. For instance, the tracking of POI requests and browsing history of POIs using the embedded AR client in the theme park application may be monitored separately from requests generated by a stand-alone AR client.

Moreover, layer proxy 408, search engine 430, POI recorder 412 and POI feedback recorder 414 may be implemented as a single network element, comprising one or more processors for executing code portions a software program product which provides the functionality of the POI ranking and search functionality as described with reference to FIGS. 5-8 and which provides an interface with the one or more content servers comprising one or more layer databases. Alternatively, layer proxy 408, search engine 430, POI recorder 412 and POI feedback recorder 414 may be implemented as a distributed system comprising various network elements, e.g. servers, and software programs executed thereon.

To further illustrate the behavior between the embedded AR client and the other parts of the AR service provisioning system, an exemplary schematic is depicted in FIG. 5. FIG. 5 depicts a schematic depicting the interactions between the embedded AR client and parts of AR service provisioning system for providing mobile AR services to the embedded AR client according to some embodiments of the invention. Schematic 500 includes a subset of components in an exemplary AR service provisioning system. The components shown includes user equipment 502, AR-related components 514, third-party application 504 running on user equipment 502, embedded AR client 506, context recorder 512, layer proxy 508, and search engine 510. User equipment 502 is implemented in a similar fashion as user equipment 102a-c, 201, 402 and 450. In particular, user equipment 502 is equipped with components 514, which includes digital imaging system, GPS receiver module, magnetometer, accelerometer, user input interfaces, and any other suitable components for supporting AR features.

During operation, the activated embedded AR client 506 provides AR content and features to the user by accessing information such as location and direction from components 514, and transmits requests to layer proxy 508 to retrieve layer content. For instance, the embedded AR client may transmit a request comprising the longitude and latitude location, and the name/identifier of a layer authored by the third-party application (e.g., a unique ID for the layer), to retrieve POIs within that layer in user equipment 502's vicinity. Layer proxy 508 returns the POI as a response back to embedded client 506 on user equipment 502, such that the returned POIs can be displayed. Advantageously, by providing the identifier for the layer (e.g., by passing the identifier as a parameter when activating the embedded AR client), the third party application effectively controls which layer the embedded AR client is intended/authorized to view and/or access.

In order to allow the AR platform to support different types of AR clients, request originating from clients contain client_type_information, e.g., in the form of a client_type flag/field, allowing the layer proxy to distinguish between request associated with different AR clients. Further, in order to link an embedded AR client to a number of authorized layers, i.e., the layers authorized by developer of the application, an authorization procedure is executed.

To that end, the embedded client may be registered to an authorization module in the layer proxy on the basis of a client_ID field. Upon registration, the client and the authorization module may share a common secret key. The secret key may be somewhere hidden in the binary file and allows a client to sign a request using a secure function, typically a hash function, and send the signed request and the client_ID to the layer proxy.

A GetPOI request, associated with an embedded client may comprise a flag/field (e.g., CL_flag=1 versus CL_flag=1). If the proxy detects the flag, it may determine that the request originates from an embedded client so that, the request is relayed to an authentication module for authenticating and authorizing the request of the embedded client. The authentication and authorization process is required in order to prevent that an embedded AR client could request any layer. Once authenticated and authorized the embedded AR client is given access to the requested layer information, so that the AR client is capable of displaying the layer in e.g. AR view to the user. Hence, from the above it follows that the embedded AR client allows restricted access to one or more predetermined of layers. In contrast with a stand-alone layer browser, it does not allow a user to freely browse layers.

When an AR client is being used as an embedded AR client, the requests being sent to a layer proxy, e.g., a HTTP GET request getPOI or other types of requests for data/content, may include certain parameters for purposes of authentication and/or authorization. In a stand-alone AR client, authentication is typically performed by checking a particular user's credentials. Based on the user's credentials, access is granted for a set of layers. However, in embedded AR clients, user authentication cannot be performed as easily as in the stand-alone case because users are brought to the AR client by the third-party application, without regard whether the user of the third-party application has a registered user account with the AR service provisioning system. Accordingly, a different authentication and/or authorization mechanism may be needed.

Furthermore, by controlling third-party applications' access to layers can ensure that not any third-party developer can build an application based on any published layer. Access control makes sure that only the third-party developer's own application can provide access to the content provider's own layer content. For instance, the content provider for a particular layer may wish to be the sole developer who can have a third-party application that embeds the AR client configured to provide access to that particular layer.

To perform authentication, for instance, the request may include a signature of embedded AR client 506, created using any suitable authentication method, e.g., asymmetric-key algorithms, symmetric-key algorithms, one-way hash functions, etc. The signature may be transmitted as part of the HTTP header. Authentication allows the AR provisioning system to verify that the request came from a genuine, legitimate embedded AR client. In one embodiment, layer proxy 508 (or any suitable authentication system) keeps a list of secret keys associated with third-party applications that have the embedded AR client. Embedded AR client 508 may use its associated secret key to sign its requests that are sent layer proxy 508. Once authenticated, layer proxy 508 may perform authorization methods to determine what type of content embedded AR client 506 is allowed to access. This may be implemented as one or more look up tables (e.g., access control lists), which stores a mapping of identities of the embedded clients to identities of the respective layers that the associated embedded client has the authorization to access.

The authentication and authorization mechanisms may work together to provide access control on the content provided by the AR service provisioning system. Preferably, the embedded AR client only provides limited access to layer content that is provided by the AR service provisioning system, whereas the stand-alone AR client can allow a user to access more layer content that is available from the AR service provisioning system.

A third-party developer may not wish to allow the user to access layer content other than content belonging or approved by the third-party developer. For instance, the illustrative theme park application (with families being its target user group/audience) may only wish to allow users to view its own layer content, which may have been reviewed and approved for its respective audience. In some embodiments, the third-party application may control the content made available to the user via the embedded AR client by means of setting and/or transmitting certain search or context parameters in its requests to layer proxy 142 (of FIG. 1).

In some embodiments, the authentication and authorization mechanisms used in connection with embedded AR client 506 may allow users to access layer content for a particular layer for free (e.g., when the access to the layer is invoked by the third-party application), whereas a user may be required to purchase access to that particular layer when the user is using the stand-alone client. For example, a third party application may advertise, e.g., “By purchasing/using our application, you get free access to our layer!” Authentication and authorization checks to make sure that free access is only provided to legitimate embedded clients.

In some embodiments, embedded AR client 506 transmits a request to retrieve other relevant content for the user, wherein the other relevant content is not content that is authored or provided by the third-party developer. Or alternatively, the other relevant content is not content that embedded AR client 506 is configured to view/access. Preferably, when the user activates the content discovery process, and a request is transmitted from embedded AR client 506 through layer proxy 508 to search engine 430 to query for relevant content that may be interesting and/or salient to the user. The retrieval of layer content preferably returns a list of POIs. The icon or any suitable identifier associated with the layer in which the POIs belong to (e.g., as indicated in the POI's metadata) may be displayed to the user via the display on the user equipment.

To provide better search results, the request for relevant content is constructed to include contextual information. To create these requests, contextual information is recorded and monitored by context recorder 512 (e.g., by recording user activity and/or POI requests/responses in the memory of user equipment). In some embodiments, context recorder 512 collects contextual information from third-party application. For instance, third-party application may provide keywords or search filters to context recorder 512. In some instances, third-party application 504 may configure context recorder 512 with search filters that the third-party developer desires. In another instance, third-party application may provide metadata that describes the nature of the third-party application, such as the genre, target age group, etc. In one example, third-party application 504 may indicate that it is a shopping application, and provides this information to context recorder 512 so that requests for relevant content includes a search term “shopping”.

In some embodiments, context recorder may also record user details, provided by any suitable source. User details may include location, name, direction, age, hometown, personal interests, or any other suitable profile information. The user details may be retrievable from user equipment 502, or may be provided by third-party application 504. User details can be used to construct a request for relevant content. For example, if it is known that the user enjoys scary movies (based on known details about the user from his/her user profile), context recorder 512 uses that information to construct a request for relevant content. The request may include a search term for “movie theatres” or “scary theme park attractions”.

In certain embodiments, context recorder may record information about the user interactions on embedded AR client 506 as context events. Such interactions may include listing of POIs that have been retrieved, selected and/or viewed, or any media items that have been downloaded or interacted with. The recorded interactions may be used to infer details about the user. Said details may be used in the request for relevant content. For example, if the user has interacted with mostly restaurant-type POIs, the request for more relevant content may include a keyword or filter for “restaurants”. Any suitable inference methods may be used for inferring contextual information about the user based in part on the user interactions recorded by context recorder 512. Each recorded context event may comprise POI metadata identifying the POI (e.g. the POI_ID), a layer identifier identifying the layer to which the POI belongs, event timing (timestamp), keywords that describe the POI and/or the layer, geo-information, e.g. coordinates of the POI and the distance with respect to the AR client and information identifying the type of event, e.g. POI selection or activation of a user selectable service or program e.g. an SMS, an e-mail message, a widget, a game, etc.

In some embodiments, the requests (getPOIs, or any suitable “get” retrieval/search requests, e.g., getLayerDetails) include parameters such as search terms or any suitable contextual parameters for specifying a search query for POIs or other layer content. These search terms, managed by context recorder 512 may provide contextual information about the user, the user equipment, or the third-party application. These search terms may be provided by the user, the third-party application or the embedded AR client. For instance, the illustrative theme park application may provide the word “hotels” as a parameter to the getPOI requests to ask for only accomodations-related POIs to be returned in the user equipment's vicinity. In another example, the theme park application provide the age group of the user using the user equipment to ask for age-appropriate content to be returned. In yet another example, a user may provide his/her own search term as a parameter to search for layer content that matches the user-provided search term. In a further example, the third party application may provide state, history or contextual information about the third-party application, the user equipment and/or the user as a parameter to a search request. For example, information about previously viewed content or user input may be provided as a parameter to guide the retrieval of layer content.

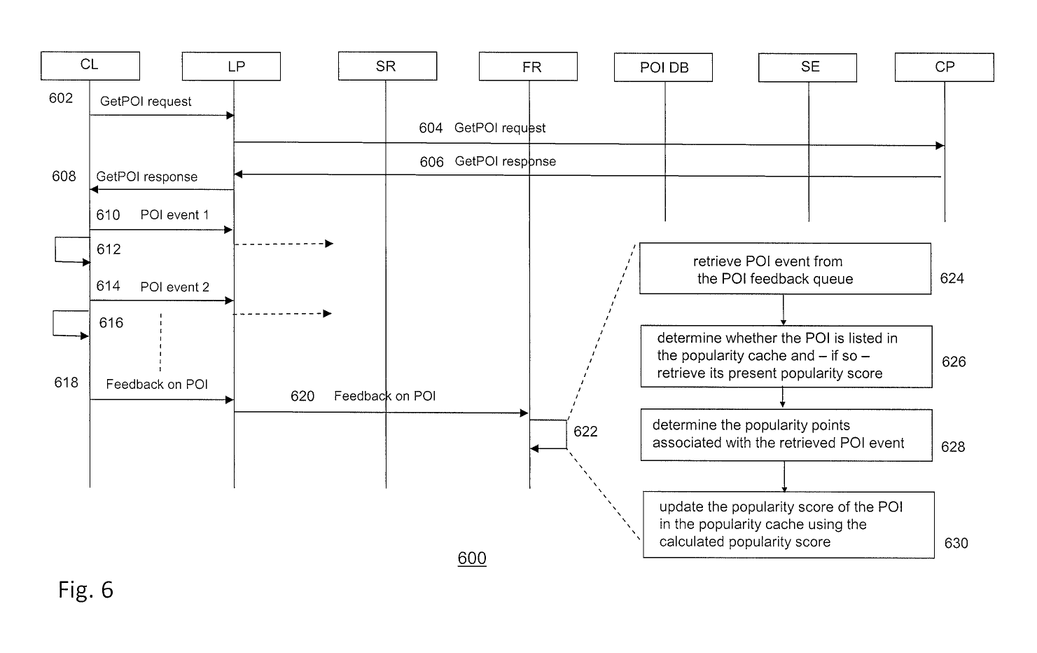

One of features of the AR service provisioning system is the POI feedback process, which facilitates the ranking and indexing of POIs of the system. Through this POI feedback process, the AR service provisioning system is able to search, retrieve, and provide POIs to AR clients based on a given search query. Details of these processes are shown and described in FIGS. 6-8.

FIG. 6 depicts an exemplary flow diagram 600 of a POI feedback process according to one embodiment of the invention. Typically, the POI feedback process comprises a POI feedback function, which may run as a background program in the AR client, and a POI feedback recorder, which may be hosted on the layer proxy or, alternatively, on a separate server connected to the layer proxy. The POI feedback recorder receives POI feedback event information and processes the POI events using a popularity algorithm.

The POI feedback function may monitor AR client activities such as user interactions with the GUI of the UE, in particular user interactions with POIs associated with a layer displayed in the AR camera view on the screen of the mobile device. Typically, the POI feedback function monitors these POI interactions by examining the protocol messages (e.g. http, ftp, SIP, etc.) and their content, which are sent and received by the AR client.

The process illustrated in FIG. 6 starts with a user selecting a layer, via either the stand-alone AR client or the embedded AR client. In some embodiments having the embedded AR client, the layer is alternatively selected by the third-party application, rather than the user. Upon selection, the AR client, embedded or stand-alone, will request the POIs associated with the layer by sending a getPOI request to the server of the content provider of the selected layer and receiving the POIs in a getPOI response from the content provider (steps 602-608). For an embedded AR client, the request may include specifics such as fields, signatures, and/or parameters as described in relation to FIG. 5.

The AR client subsequently displays the layer and its associated POIs, which are located within a certain range from the UE, on the screen of the UE. Thereafter the user may select one or more POIs from the screen so that an information exchange with the proxy server (step 610) is triggered. When a message associated with a POI user interaction is identified, it extracts the relevant POI information from the identified message and stores the POI information as a POI event in a memory of the UE (step 612).

For example, when a user selection of a POI activates the displaying of a graphic box comprising a video activation button and the user subsequently selects the button thereby activating a media player for displaying the video, the POI feedback function may record a first POI event associated with the opening of the POI and second POI event associated with the activation of the video displaying. Each recorded POI event may comprise POI metadata identifying the POI (e.g. the POI_ID), keywords that describe the POI and/or the layer, a layer identifier identifying the layer to which the POI belongs, event timing (timestamp), geo-information, e.g. coordinates of the POI and the distance with respect to the AR client and information identifying the type of event, e.g. POI selection or activation of a user selectable service or program e.g. an SMS, an e-mail message, a widget, a game, etc.

The POI feedback function may collect and store a predetermined number of such POI events (step 614, 616) before it sends the POI feedback information in a POI feedback message (step 618), using e.g. a http POST message, to the layer proxy, which subsequently relays the message to the POI feedback recorder (step 620). The POI feedback information is stored in a POI event queue, which is processed by a popularity algorithm, which assigns popularity points to a POI on the basis the POI event information and stores the POI and its popularity score in a popularity cache (step 622).

The processing of POI events involves retrieval of a POI event from the POI feedback queue (step 624); determine whether the POI is listed in the popularity cache and—if so—retrieve its present popularity score and average interaction distance (step 626); determine the popularity points associated with the retrieved POI event using the popularity algorithm and the metadata associated with the retrieved POI event and determine the average interaction distance using the distance in the POI feedback information (step 628); update the popularity score and average interaction distance of the POI in the popularity cache using the calculated popularity score and calculated average interaction distance (step 630). This process is repeated for each POI event in the POI queue, which is periodically filled with new POI events originating from different AR clients in the AR system.

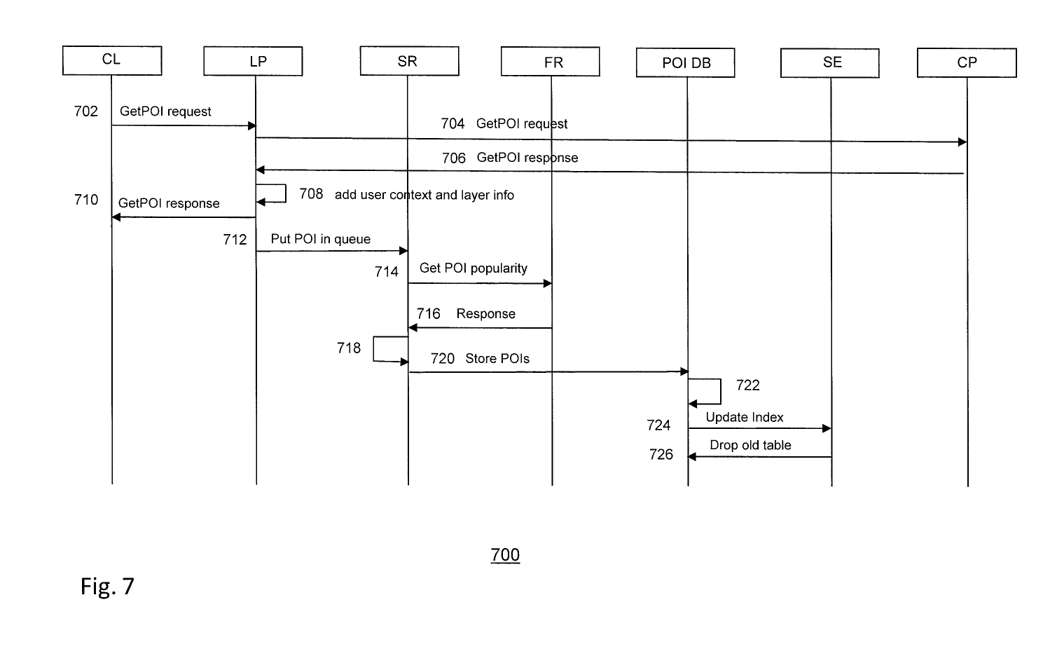

FIG. 7 depicts an exemplary flow diagram 700 of generating a ranked POI database according to one embodiment of the invention. The process starts with an AR client sending a request for POIs, e.g. a http get getPOI, associated with a particular layer, to the layer proxy (step 702), which relays the request on the basis of the metadata in the request to the layer content provider (step 704). The request may contain at least a layer identifier, geo-information, e.g. coordinates and altitude, on the position of the AR client. Optionally, the request may contain a range parameter for indicating that only POIs within a certain distance from the AR client are requested. It may also contain filter settings pertaining to the layer, e.g. to only request a certain type of POIs for that layer like only Italian restaurants in a restaurant layer or to restrict a value characterizing the POIs being returned like the price range of houses for sale. Furthermore, the request for POIs may include specifics (e.g., fields, parameters, and/or signatures) relating to requests used by an embedded AR client as discussed in relation to FIG. 5.

In response to the request, the layer content provider may determine the relevant POIs and send these POIs in a getPOI response back to the layer proxy server (step 706). Upon reception of the POIs, the layer proxy may retrieve relevant layer information and user data from the layer database and add this information to the getPOI response (step 708), which is subsequently sent to the AR client (step 710). The getPOI response may at least comprise a list of POIs identified by their POI_IDs and the layer name to which the POIs belongs. Each POI in the getPOI response further contains metadata such as text (title, description), interactions that a user can have with the POI such as URLs for fetching web pages, videos, audio files and URIs for placing phone calls, sending emails and text messages to instances associated with the POI. An POI in the GetPOI response may also contain data for representing the POI in the AR client, such as images, icons, 3D files and metadata instructing the AR client how to represent the object in space such as rotation angle, size and scaling factor. The proxy further relays the response to the

POI recorder, which stores the POIs in the response, in the POI queue (step 712). Each entry in the POI queue may comprise the POI_ID uniquely identifying the POI in the AR system, the coordinates of the POI, the textual metadata of the POI and characteristics of the POI (is it a 3d object, what type of interactions does it allow) and other metadata (e.g. contextual information) stored in the layer database.

The POI update function subsequently generates a POI list on the basis of the POIs in the POI queue and the POIs in the popularity cache. To that end, the POI update function retrieves a POI entry from the POI queue (step 714) and determines on the basis of the POI_ID whether the POI is listed in the popularity cache (step 716). If so, the ranking function retrieves the popularity score and—if the POI is listed in the POI database—the POI in the POI database is updated with respect to its popularity score (step 718). If the POI is not listed in the POI database, the POI and its popularity score is added to the list (step 720). In this way, the POI database comprises a constantly up-to-date list of POIs identified by the POI_IDs and assigned popularity points reflecting the popularity and relevancy of the POI as determined by the users of the AR system.

After a predetermined period of time, a copy of the POI list in the POI database is indexed for generating a new indexed POI file (step 722), which replaces the old indexed POI file (step 724).

As described in with reference to FIG. 4, each POI entry in the POI database comprises a POI_ID, a popularity score, geo-coordinates, the average interaction distance, timestamp relating to the time of update and metadata from the layer database (e.g. keywords, user-added standardized POI index, etc.). Hence, after indexing the information in the POI database, a search engine may use the popularity score in combination with the other parameters for ranking the searched POIs.

A search engine may access an indexed POI file for searching relevant POIs on the basis of a search query text, geo-information, distance information, contextual information and popularity score. For example, when the embedded AR client requests for relevant content in the content discovery process, the AR service provisioning system may employ this method of searching for relevant POIs that are interesting and/or salient to the user. In some embodiments, the embedded AR client uses the context recorder to construct said requests.

The process of generating an indexed POI file may be periodically repeated, e.g. every 10-5 minutes or less, such that a POI search is always based on the most recent updated POI list in the POI database. Especially with POIs, which are highly dynamical, e.g. a POI representing a Twitter tweet placed by a certain person on a specific location, fast updates are required in order for the system to generate relevant results, which are usable for a user.

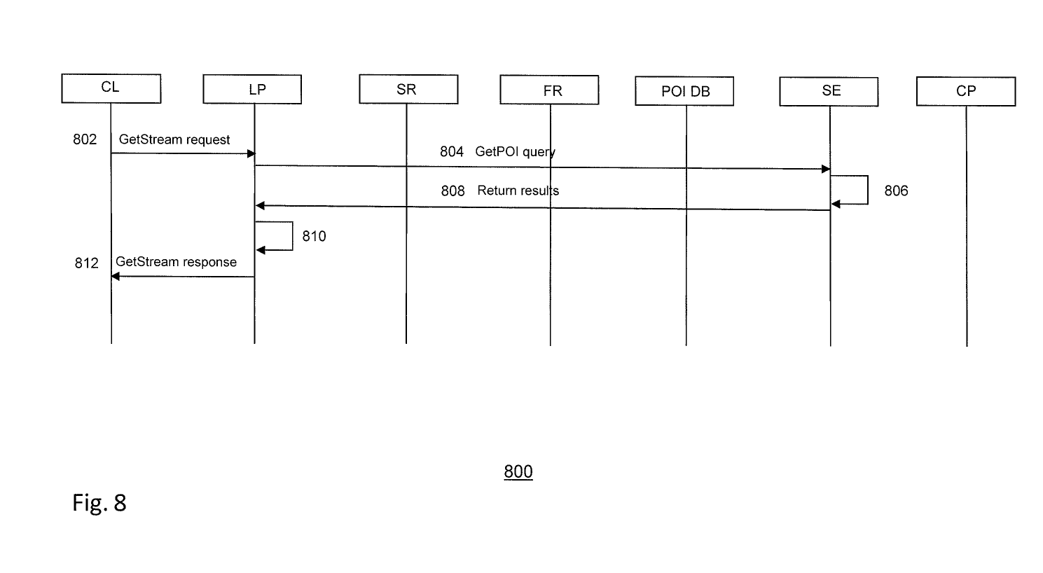

FIG. 8 depicts an exemplary flow diagram 800 of the execution of a POI search according to one embodiment of the invention. When the user decides to perform a POI search, he or she may activate the POI search function in the AR client. In some embodiments, the POI search function is activated by the embedded AR client when the embedded AR client receives user input indicating that he/she wishes to discover more content. Upon receiving the user input, the embedded AR client, preferably in conjunction with the context recorder, constructs a request that would invoke a POI search function. The POI search function may allow the user to enter a search query or, alternatively, it may decide to perform a search solely on the basis of the geo-information of the AR client. In certain embodiments, the POI search function may perform a search based at least in part on information provided by a context recorder of an embedded AR client. Furthermore the POI search function may allow the user to select filters in order to restrict the search to specific set of POIs (e.g. only POIs from layers with category ‘restaurants’). Then the AR client may send a search request, e.g. a http GET getStreamItems message, comprising the coordinates of the mobile device and, optionally, the search query to the layer proxy or filter parameters (step 802), which subsequently relays the search request to the search engine (step 804). This search process may be used for either stand-alone or embedded clients. For an embedded AR client, the search request may include specifics such as signatures, fields, and/or parameters as described in relation to FIG. 5.

In response, the search engine may execute a POI search in the indexed POI list using the coordinates and the optional query and optional filters as parameters (step 806) and generate a list of “local” POIs each being identified by a POI_ID, layer name and geo-coordinates, which are within a predetermined range of the AR client. The POIs may be ranked in accordance to the ranking parameters as described with reference to FIG. 4. These ranked results may be subsequently returned in a getStreamItems response to the layer proxy (step 808), which may optionally further filter the results and/or add further layer information and/or user data to the POIs (step 810). The getStreamItem response is then further relayed to the AR client in the UE (step 812) and displayed by a GUI as a list of POI items. In embodiments where an embedded AR client requests for relevant POIs as a result of receiving user input indicating the desire for more content (i.e., in the content discovery process), the getStreamItem response may return identifiers of the layers to which the retrieved POIs belong, and the user equipment would display a list of the layers on the GUI (e.g., icons, names in text).

In one embodiment, the AR client may comprise a refresh function configured to dynamically update the list of POI items as a function of location. Hence, after a user has executed a search on the basis of the geo-coordinates of the UE, the most popular POIs are displayed to the user as a ranked list of POI items. When the user moves to a new position, the refresh function in the AR client may be triggered to send a getStreamItems message to the layer proxy in order to receive a getStreamIntems response comprising a new list of ranked POIs associated with the new location of the user, which may be presented to the user. Hence, when moving the refresh function in the AR client may receive a “stream” of POI items, which are used by the AR client to constantly update the ranked POI item list.

While it is to the third-party developer's advantage that AR functionality is provided to the user on third-party application via the embedded AR client, it is to the AR service provider's advantage to make other/further AR content available to the user. To the AR service provider, it is advantageous to have more users install the stand-alone AR client on their user equipment, such that they can discover more AR content outside of using the embedded AR client that is provided by the third-party application. However, at the same time, the third-party application developer/provider does not what to be associated with other layer content, nor wish to distract their users from using the third-party application. Furthermore, it is undesirable for the third-party application (and the embedded AR client) to be used for other types of content that is not sponsored/provided by the third-party application.

To alleviate this problem, the embedded AR client provides a functionality to allow users to use a preferably non-intrusive gesture or a movement to initiate discovery of more layer content. The layer content to be discovered may include: layer(s) associated with other content providers, further content that is not available to the embedded client, and/or further content that the embedded client is not authorized/configured (by the third-party developer) to access. For example, a shaking gesture may initiate a request asking for more layer content. A toss gesture may initiate a request for more POIs. The request may include contextual information from the third party application, the user or the embedded AR client. Based on the results of the request, an abstract or summary of the results (e.g., a digest) may be displayed to the user, as to not directly display content that the embedded client is not allowed to directly see through the embedded client.

FIG. 9 shows an illustrative flow diagram of the method for providing a list of relevant layers (i.e., abstract/summary search results) to the user, according to one embodiment of the invention.

When the AR client is being used through the third-party application, it may be configured to only access certain content or layers (content that is associated with the third-party application). While the user is using an embedded client, the user may shake (or toss) the phone to indicate that he/she is interested in discovering more content (box 902), further content that is not intended to be accessible by the embedded client. Other types of user input, preferably non-intrusive, may be used. Once the user equipment receives the user input, the embedded AR client then transmits a request to the layer proxy to request for content that is relevant, interesting, and/or salient to the user. The content may be in the scope of the further content, i.e., content that was not intended to be accessible by the embedded client.

To aid in finding that content, context parameters and geo coordinates (and any other suitable parameters) may be used. In certain embodiments, a context recorder for use with the embedded AR client provides the context parameters to be used. The request transmitted to the layer proxy may be a getPOIs request or a getStreamItems request. For an embedded AR client, the request(s) may include specifics such as fields, parameters, and/or signatures as described in relation to FIG. 5.

Once the request is received at the layer proxy, the request is forwarded to a search engine such that a list of relevant POI(s) can be retrieved. The search engine may search an indexed file using parameters given by the request. The search results may be ranked based on indicators such as popularity and lifetime. Accordingly, the layer proxy generates a ranked list of relevant POIs (box 906). Based on the ranked list of relevant POIs, the metadata associated with those POIs is retrieved (box 908). In some embodiments, the metadata is included in the search results provided by the search engine.

Using the metadata associated with the retrieved POIs, the layer(s) to which these retrieved POIs belong is determined. Based on this determination, a list of layers to which these retrieved POIs belong is compiled from the metadata (box 910). The list may include at least one of: unique identifiers for the layer(s), the names of the layer(s) and URLs for the image icons associated with the layers. The metadata is then used by the embedded AR client to generate a graphical overlay for displaying a list of layers (box 912). In the illustrative embodiment shown, a filmstrip-like graphical overlay 914 displaying several icons 918a-c associated with the relevant POIs is shown on top of the screen 916. The abstraction of the POIs to layers is displayed to the users (e.g., providing a digest of the POIs) because it is preferable that the embedded AR client displays the layer icons rather than the POIs themselves. In particular, when an embedded AR client is configured to only allow access to the layers that the third-party developer has authored/provided, it is preferable that content from other layers (as retrieved by this discovery process) is not displayed. Rather, an abstract or summary representing those relevant POIs (e.g., a digest) are displayed to the user.

FIG. 10 shows an illustrative flow diagram of the method enabling user discovery of content, in accordance with one embodiment of the invention.

Rather than prompting the user to leave the third-party application substantially right after receiving the user input indicating an interest to discover content, the embedded AR client may display teaser information to the user. This teaser information may be a preview or an abstract of what other content may be relevant and available to the user. By avoiding sending the user away from the third-application directly, this teaser information serves as a less intrusive mechanism for leading users to discover other content. Through the teaser, the user can see what other content may be available before leaving the third-party application.

For instance, once the user initiates discovery of content, the embedded AR client may transmit a request to the layer proxy, such that a search is performed to look for more layer content (e.g., such as relevant POIs in the area). The request may be based at least on contextual information provided by the third-party application, the embedded AR client, or the user. The search results may be used in part to generate a teaser preview of other content that is relevant to the user. Said teaser preview may be in the form of a list of icons associated with the other content. For instance, the teaser preview may include a list of layer icons, wherein the icons are associated with the layers to which the relevant POIs belong.

To illustrate, process 1000 describes the method of discovering content. A user begins by using a third-party application that has the AR client embedded in manner described herein. A link, button, or any suitable means may be provided to the user to activate the embedded AR client. At a suitable time, the embedded AR client is activated to allow the user to enjoy AR content and features.

Preferably, a third-party application or developer may configure the embedded AR client to suit the third-party application's requirements. For instance, contextual information about the user or the third-party application may be provided to the embedded AR client. In some embodiments, the requests for content transmitted by the embedded AR client to the layer proxy include contextual parameters provided by the third-party application. Those parameters may be used for authentication, authorization, and/or search filters. For instance, parameters may include a signature for authentication. In another instance, parameters may include search filters. In some embodiments, parameters are included to select which layer(s) to display on the embedded AR client.

While enjoying AR content that the embedded AR client is configured to provide (box 1002), the user may desire to discover other content. In some embodiments, the other content is not fully accessible by the embedded AR client, or the embedded AR client is not configured to provide full access to that content. Accordingly, a first input indicating the user's interest to discover more content is received (box 1004). In some embodiments, the other content is not available via the embedded AR client, or the embedded AR client is not configured to provide the other content that the user desires to discover.

Preferably, the mechanism (e.g., the type of user input) allows users to discover more content in a manner that is the least intrusive as possible to the third-party application. That is, the mechanism that allows the user to discover other content should interfere with the third-party application as little as possible.

In some embodiments, a faint-colored logo or link may be provided to the user on the screen of the embedded AR client. A user may click on the faint-colored logo (e.g., an image with a low opacity) to indicate a desire or interest to discover other content.

In certain embodiments, the embedded AR client accepts a motion gesture as a first input that indicates an interest to discover more content. For instance, a user may shake the mobile phone to indicate that he/she may be interested in more AR content. Besides motion gestures, the user input is may include other kinds of user input such as in-air hand gesture, in-air finger gesture, shaking motion, audio input, vocal input, tossing motion, vocal input, touch-based hand gesture, gaze input, head gesture, and haptic input.

For example, while the user is using the embedded AR client of the theme park application to view attractions in the theme park in AR camera view, the user may use a tossing motion to indicate that more content is desired. In another example, a swiping motion over the touch screen of the user equipment may be used to request for more content.

Upon receiving the first user input, the embedded AR client transmits a request to the layer proxy to retrieve more content for the user (box 1005). For an embedded AR client, the request may include specifics such as fields, parameters, and/or signatures as described in relation to FIG. 5. The request may be a retrieval/search request, implemented in a manner in accordance with this disclosure. Preferably, the search space includes other content that is not accessible via the embedded AR client, or that the embedded AR client is not configured to access the other content.

In some embodiments, the request includes contextual information about the user, the third-party application, or history/state of the embedded AR client. In some cases, the contextual information may be used as keywords for a search filter in a search query. If context information (e.g., parameters) provided by the third-party application is used, the system gives the third-party application more control over the search results to be displayed in the teaser. If any contextual information is used, the search results may be advantageously more tailored to the user and/or the moment in time. For instance, the age of the user may be passed on to the layer proxy as a parameter in the request to ensure that the search results returned are age-appropriate. In another instance, the personal characteristics/interests of the user (e.g., music, sports, personality, etc.) may be passed on as parameters to guide the search query as well.

The request for other layer content (i.e., a request that invokes a search query executed at the layer proxy, e.g., getPOIs, getStreamItems) preferably returns a list of POIs, in a manner as described in this disclosure. The icon or any suitable identifier associated with the layer to which each of the POIs belongs to (e.g., as indicated in the POI's metadata) may be displayed to the user via the display on the user equipment. In any suitable manner, abstract search results (or a digest) are displayed (box 1006) to the user via the display of the user equipment using the POI metadata.

In other words, the specific POIs returned from the search query are not displayed to the user. Rather, an abstract—i.e., the icons of the layers to which the POIs belong to—representing the returned POIs are displayed in the teaser. In some embodiments, the user may see a list of icons displayed on the screen like a film strip comprising of a series of icons or pictures. Preferably, the abstract search result (or a digest) may serve as a teaser to allow the user to get a taste of what other content is available to the user through a separate, stand-alone AR client. For instance, the film strip of icons may be titled as “other things that may interest you”.

In the theme park application example, a list of related POIs may be retrieved in response to the request transmitted to the layer proxy (e.g., getPOIs, getStreamIterms). Based on the list of related POIs retrieved, the metadata of the related POIs are retrieved. Using that metadata of the related POIs, the layers to which the POIs are associated is identified and the icons of those layers are provided to the user. Those icons are displayed as part of the abstract search results (e.g., as a digest) on the user equipment.

In some embodiments, the embedded AR client is configured to only access a selected set of layer(s) prescribed by the third-party application. The display of abstract search results rather than the POIs themselves helps to make sure that other POIs/content is not directly displayed to the user and made readily accessible to the user via the embedded AR client.

After viewing the abstract search results, the user may select part of the search results by, e.g., pressing on any of the icons displayed in the abstract search results. Accordingly, a second input selecting part of the search results is received (box 1008) at the user equipment. The selection of part of the search results serves as an indication that the user would like to access and/or view the content associated with the selected part of the search results.

To access the content associated with the selected part of the search results (i.e., content that is not available on the embedded AR client), the stand-alone client is preferably activated (rather than the embedded AR client). Therefore, once the second user input selecting part of the search results is received at the user equipment (box 1008), the embedded AR client checks whether a stand-alone AR client is available for use (e.g., installed, configured) on the user equipment (box 1010). For instance, the embedded AR client may access the user equipment and checks a list of installed applications on the user equipment for the stand-alone AR client (e.g., a computer registry).

In the case where a stand-alone client is not already available on the user equipment, the embedded AR client prompts the user of further possible step(s) to access the other content. To discover other content (i.e., content that is not available on the embedded AR client), the user may need to download and/or install the stand-alone client on the user equipment. In some embodiments, the user may need to configure the user equipment in a suitable manner to use a stand-alone AR client outside of the environment provided by the embedded AR client.

Accordingly, the embedded AR client prompts the user that he/she is leaving the third-party application to obtain the stand-alone client (box 1012). The user may then agree or disagree to leave the third-party application. For example, a pop up box may appear on the display of the user equipment asking, “You are about to leave the theme-park application to download the stand-alone Augmented Reality client.” The user would be prompted to select whether to “PROCEED” or “CANCEL AND RETURN TO THEME-PARK APPLICATION”. The prompt that notifies the user that he/she is about to leave the third-party application helps to make sure that the process of user-initiated discovery of content is the least intrusive as possible to the third-party application. In this manner, users do not leave the third-party application without notice.

According to the above illustrative example, if the user selects “PROCEED”—then he/she may be directed to a screen to configure the user equipment to run the stand-alone client (see box 1014). The user may be provided with an opportunity to obtain the stand-alone AR client. For instance, the user may be directed to a screen within a mobile application store to download/install the stand-alone AR client. Alternatively, the download/installation of the stand-alone client may begin automatically after the user agrees to leave the third-party application. Once installed, the user may launch the stand-alone client to discover more content. In some embodiments, the stand-alone client may initially display search results related to any contextual parameters that was passed to the embedded AR client.

In the case where a stand-alone client is already available on the user equipment, the embedded AR client prompts the user of further possible step(s) to access the other content. Even though the stand-alone client is already installed, the user may still be prompted that the user is about to leave the third-party application (box 1016), in a similar manner as described in relation to box 1012. However, in contrast to box 1014, the user equipment is directed to launch the stand-alone AR client (box 1018) once the user agrees to leave the third-party application.

Once the stand-alone AR client is launched, the content associated with the selected part of the search results is made available to the user. For instance, if the user selected the “McDonalds” icon from the abstract search results, individual POIs representing nearby

McDonalds restaurants would be displayed on the stand-alone AR client, in list, map, or AR camera view. In some embodiments, the user is required to log in if user credentials to the augmented reality service provisioning system are not readily available to the stand-alone AR client. This may be advantageous in systems were access to layers is controlled by user-based authentication.

In general, leading the user to boxes 1014 and 1018 is advantageous to the AR service provider because the user is able to either become a first time user of a stand-alone AR client, or is able to utilize the existing AR client more. In either cases, the user is guided to enjoy and discover more AR content, in particular, AR content that is not made available to the user via the embedded AR client. At the same time, the intrusiveness of the content discovery process is intended to be as little as possible, thereby making sure that the third-party developer's interests are protected.

One embodiment of the invention may be implemented as a program product for use with a computer system. The program(s) of the program product define functions of the embodiments (including the methods described herein) and can be contained on a variety of computer-readable storage media. The computer-readable storage media can be a non-transitory storage medium. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory, flash memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

Finally, although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. A method for enabling content discovery on a user equipment in an augmented reality service provisioning system, the method comprising:
providing a first augmented reality client for running on the user equipment, wherein the first augmented reality client is embedded in a third-party application, and is configured to allow a user to view one or more first content items offered by the augmented reality service provisioning system;
receiving a first user input through a user interface provided by the user equipment, wherein said first input indicates a user's interest to discover further content different from the one or more first content items, wherein the first augmented reality client is not configured to view the further content;
in response to receiving the first input, transmitting a request for the further content to a server in the augmented reality service provisioning system to retrieve one or more second content items within the scope of the further content; and
providing a digest of the one or more second content items retrieved, at least part of the digest to be displayed on the user equipment.

2. The method according to claim 1, said method further comprising:
receiving a second user input through the user interface, wherein said second input indicates a user's selection from at least part of the digest displayed on the user equipment; and
in response to receiving the second input, providing an graphical object to the user interface prompting the user with an option to execute a second augmented reality client outside of the third-party application for accessing the one or more second content items.

3. The method according to claim 2, wherein the providing of the graphical object to the user interface comprises:
determining whether the second augmented reality client is already installed on the user equipment; and
if the second augmented reality client is not already installed, providing the graphical object to the user interface prompting the user with an option to obtain the second augmented reality client for the user equipment.

4. The method according to claim 2, wherein the providing of the graphical object to the user interface comprises:
determining whether the second augmented reality client is already installed on the user equipment; and
if the second augmented reality client is already installed, providing the graphical object to the user interface notifying the user that the one or more second content items related to the user's selection is viewable using the second augmented reality client and/or notifying the user is about to leave the third-party application to view the associated content.

5. The method according to claim 1, wherein the first augmented reality client is embedded as a binary code package within the third-party application.

6. The method according to claim 2, wherein said one or more second content items related to the user's selection is not viewable using the first augmented reality client, and is viewable in the second augmented reality client.

7. The method according to 2, further comprising providing the one or more second content items to the user equipment using the second augmented reality client.

8. The method according to claim 1, wherein the first input comprises at least one of: an in-air hand gesture, an in-air finger gesture, a shaking motion, an audio input, a vocal input, a tossing motion, a vocal input, a touch-based hand gesture, a gaze input, a head gesture, and a haptic input.

9. The method according to claim 1, wherein the request for further content comprises at least one of a user equipment's location, a parameter specified by the third-party application for limiting the search query, contextual information, and a parameter specified by the user.

10. The method according to claim 1, wherein the request for further content comprises a signature parameter for authenticating the first augmented reality client transmitting the request as a legitimate augmented reality client authorized to access the augmented reality service provisioning system.

11. The method according to claim 1, wherein the retrieving of the one or more second content items comprises:
retrieving at least one point of interest data based at least in part on the request;
retrieving metadata associated with the retrieved points of interest; and
wherein the digest comprises the retrieved metadata.

12. The method according to claim 11, wherein the displaying of the digest comprises displaying at least one graphical icon associated with the retrieved metadata.

13. The method according to claim 1, further comprising:
recording contextual information comprising at least one of: information on user interaction associated with the first augmented reality client, information associated with the user, information associated with the third-party application, information associated with the first augmented reality client; and
transmitting the contextual information in the request for retrieving the further content.

14. A computer program product, implemented on computer-readable non-transitory storage medium, the computer program product configured for, when run on a computer, executing a method comprising:
providing a first augmented reality client for running on the user equipment, wherein the first augmented reality client is embedded in a third-party application, and is configured to allow a user to view one or more first content items offered by the augmented reality service provisioning system;
receiving a first user input through a user interface provided by the user equipment, wherein said first input indicates a user's interest to discover further content different from the one or more first content items, wherein the first augmented reality client is not configured to view the further content;
in response to receiving the first input, transmitting a request for the further content to a server in the augmented reality service provisioning system to retrieve one or more second content items within the scope of the further content; and
providing a digest of the one or more second content items retrieved, at least part of the digest to be displayed on the user equipment.

15. A client device for use in an augmented reality service provisioning system, the client device comprising:
a graphical user interface configured to allow a user to view one or more first content items offered by the augmented reality service provisioning system;
a user interface configured to receive a first user input provided by the user equipment, wherein said first input indicates a user's interest to discover further content different from the one or more first content items, wherein the client is not configured to view the further content;
a communication module configured to, in response to receiving the first input, transmit a request for the further content to a server in the augmented reality service provisioning system to retrieve one or more second content items within the scope of the further content; and
the graphical user interface configured to provide a digest of the one or more second content items retrieved, at least part of the digest to be displayed on the user equipment.
